(19) United States
(12) Patent Application Publication
(10) Pub. No.: US 2008/0024606 A1
(43) Pub. Date: Jan. 31, 2008

(54) Image processing apparatus

(75) Inventor: Naoki Kawasaki, Kariya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/821,120

(22) Filed: Jun. 21, 2007

(30) Foreign Application Priority Data
Jul. 25, 2006 (JP) 2006-202576

(51) Int. Cl. H04N 7/18

(52) U.S. Cl. 348/148

(57) ABSTRACT

An image processing unit for use in a vehicle has a camera for capturing an image of a field around the vehicle, and the image captured by the camera is used to estimates an external environment of the vehicle. The external environment of the vehicle such as a luminance of the image and the like around the vehicle is estimated by using a camera control value and a pixel value of an imaging object based on a relationship that the pixel value of the imaging object captured by the camera is determined by the luminance of the imaging object and the camera control value.

### CROSS REFERENCE TO RELATED APPLICATION

This application is based on and claims the benefit of priority of Japanese Patent Application No. 2006-202576 filed on Jul. 25, 2006, the disclosure of which is incorporated herein by reference.

### FIELD OF THE INVENTION

The present invention generally relates to a vehicle image processing apparatus.

### BACKGROUND INFORMATION

Conventionally, there has been proposed a technology of determining a vehicle's running environment from an image captured by an image pickup apparatus such as a camera (e.g., see Patent Documents 1 through 4). According to the technology described in Patent Document 1, a camera is provided to a support post along a road and captures a road surface and a road shoulder. The technology compares shades of the captured images for the road surface and the road shoulder to determine the snow accumulation.

The technology described in Patent Document 2 uses a camera that captures views outside a vehicle. When an image captured by the camera contains a road surface in an area, the technology settles this area as a monitoring area. The technology detects the snow at a road shoulder based on a luminance edge in the monitoring area and the amount of change in luminance inside and outside the edge.

The technology described in Patent Document 3 defines a monitoring area in a captured image. The technology categorizes a luminance distribution of the monitoring area into any of predetermined multiple luminance distribution patterns. The technology uses a determination method individually settled for each luminance distribution pattern to determine whether or not the vehicle is running on a snowy road.

The technology described in Patent Document 4 provides imaging means for imaging a view ahead of the vehicle. An image captured by the imaging means is configured to contain a focused area and the other unfocused area. The focused area contains a vehicle running ahead, a white road line, a road sign, and the like. The technology detects luminance information about the focused and unfocused areas in the captured image. Based on the luminance information about these areas, the technology determines whether or not a running environment makes it difficult for an image process to analyze a situation ahead of the vehicle.

[Patent Document 1] JP-A-H07-84067

[Patent Document 2] JP-A-2001-88636

[Patent Document 3] JP-A-2005-84959

[Patent Document 4] JP-A-2005-135308

Generally, an onboard camera for capturing an image around a vehicle provides exposure control in accordance with an external environment during imaging such as lightness, luminance, and color. The exposure control successively adjusts camera control parameters such as an aperture, a shutter speed, and an output signal gain. The exposure control adjusts control values (camera control values) for the camera control parameters so that an object to be imaged provides a pixel value available for a subsequent image process. The pixel value represents a degree of brightness for each pixel.

When focusing attention on the exposure control, determining an external environment during imaging determines a camera control value to be adjusted to the target pixel value. It can be understood that there is a cause-effect relationship between the external environment during imaging (cause) and the camera control value (effect). The external environment during imaging can be estimated from the camera control value by retroactively keeping track of the cause-effect relationship from the effect to the cause. When this estimation is available, the other onboard applications can be provided with information about the external environment.

However, the technologies described in Patent Documents 1 through 3 determine a specific running environment such as a snowy road or the like. The technology described in Patent Document 4 determines whether or not a running environment makes it difficult for the image process to analyze a situation. These technologies cannot estimate external environments such as lightness, luminance, and color of an object to be imaged during imaging.

### SUMMARY OF THE INVENTION

The present invention has been made in consideration of the foregoing. It is therefore an object of the present invention to provide a vehicle image processing apparatus capable of estimating an environment outside a vehicle using an image captured by an onboard camera.

To achieve the above-mentioned object, a vehicle image processing apparatus includes an onboard camera for capturing an image including an imaging object around a vehicle, a camera control value setup unit for setting a camera control value of at least one of camera control parameters such as an onboard camera aperture, a shutter speed, and an output signal gain in accordance with an external environment for the vehicle during imaging, an imaging object pixel value acquisition unit for acquiring a pixel value for an imaging object in an image captured by an onboard camera, and an imaging object luminance estimation unit for estimating a luminance of an imaging object from a camera control value set by camera control value setup unit and a pixel value for an imaging object acquired by imaging object pixel value acquisition unit using a cause-effect relationship in which a pixel value for an imaging object in an image captured by an onboard camera is determined based on a luminance of the imaging object and a camera control value.

Let us suppose that exposure control is performed when the onboard camera captures an image (see FIG. 2) whose imaging range contains a road surface painted with a white line and the sky ahead of a vehicle. There is a cause-effect relationship as shown in FIG. 3 between an external environment around the vehicle and the captured image. FIG. 3 diagrams a cause-effect relationship model showing the cause-effect relationship between a variable to be estimated and a measurable variable. In FIG. 3, arrows among variables v1 through v12 indicate that the cause-effect relationship is available. An origin of the arrow corresponds to the cause and an ending point thereof corresponds to the effect of the cause-effect relationship. The variables v5 and v8 through v12 are measurable.

It will be understood that the cause-effect relationship model can be used for various estimations. For example, there is available “estimation of an effect from a measured cause (forward direction of the arrow)” or “estimation of a cause from a measured effect (backward direction of the arrow).” These estimations can be propagated along the arrows among the variables, making it possible to estimate the variable v2 or v3 not directly connected with measurable variables through the arrows.

According to the above-mentioned cause-effect relationship, an image captured by the onboard camera contains an imaging object, and its pixel value is determined based on the imaging object's luminance and the camera control value. The cause-effect relationship can be used to estimate a vehicle's external environment such as the luminance of the imaging object from a camera control value and a pixel value for the imaging object. In this manner, the other onboard applications can be provided with information about the luminance of the imaging object.

In another aspect of the present disclosure, the vehicle image processing apparatus includes an onboard camera for capturing an image including a road surface around a vehicle, a camera control value setup unit for setting a camera control value of at least one of camera control parameters such as an onboard camera aperture, a shutter speed, and an output signal gain so as to provided a specified pixel value for the road surface in the image captured by the onboard camera and a road surface luminance estimation unit for estimating a luminance of the road surface from the camera control value using a cause-effect relationship in which the luminance of the road surface is determined based on the camera control value when the camera control value setup unit sets the camera control value so as to provide the specified pixel value for the road surface.

The onboard camera may allow the exposure control to provide a specified value for the pixel value of the road surface. In such case, the cause-effect relationship model in FIG. 4B can be simplified to a cause-effect relationship model between the luminance variable v6 and the camera control variable v8 as shown in FIG. 6A. A cause-effect relationship map as shown in FIG. 6B can be used to represent the road surface luminance variable v6 and the camera control variable v8. Consequently, the road surface luminance variable v6 can be estimated from the camera control variable v8.

In yet another aspect of the present disclosure, the vehicle image processing apparatus includes an ambient illuminance acquisition unit for acquiring an illuminance around a vehicle, an onboard camera for capturing an image including an imaging object around the vehicle, an imaging object luminance acquisition unit for acquiring an imaging object luminance estimated at least based on a pixel value for the imaging object in the image captured by the onboard camera; and an imaging object lightness estimation unit for estimating an imaging object lightness from the illuminance acquired by the ambient illuminance acquisition unit and the imaging object luminance using a cause-effect relationship in which the imaging object luminance is determined based on the illuminance around the vehicle and the imaging object lightness.

As mentioned above, the exposure control may be performed when the onboard camera captures the image (see FIG. 2) whose imaging range contains the road surface painted with the lane marking (white line) ahead of the vehicle. In this case, the cause-effect relationship model in FIG. 3 is available between the external environment around the vehicle and the captured image. This cause-effect relationship model represents the cause-effect relationship in which the luminance of the imaging object such as the road surface or the white line is determined based on the illuminance around the vehicle and the lightness of the imaging object. The cause-effect relationship can be used to estimate the lightness of the imaging object from the illuminance around the vehicle and the luminance of the imaging object. In this manner, the other onboard applications can be provided with information about the lightness of the imaging object.

In still yet another aspect of the present disclosure, the vehicle image processing apparatus includes an onboard camera for capturing an image including the sky around a vehicle, a sky luminance acquisition unit for acquiring a luminance of the sky around the vehicle at least based on a pixel value for the sky in the image captured by the onboard camera, and anambient illuminance estimation unit for acquiring an illuminance around the vehicle from the luminance of the sky acquired by the sky luminance acquisition unit using a cause-effect relationship in which the illuminance around the vehicle is determined based on the luminance of the sky around the vehicle.

As is clear from the cause-effect relationship model in FIG. 3, the illuminance variable v4 is directly connected with the sky luminance variable v1. As shown in FIG. 10C, a cause-effect relationship model is available between the illuminance variable v4 and the sky luminance variable v1. There is the cause-effect relationship in which the illuminance around the vehicle is determined based on the luminance of the sky around the vehicle. The cause-effect relationship can be used to estimate the illuminance around the vehicle from the luminance of the sky around the vehicle.

In this manner, the other onboard applications can be provided with information about the illuminance around the vehicle without using the light control system sensor or the solar sensor. It is considered that the illuminance variable v4 is estimated from the sky luminance variable v1 not so accurately. As shown in FIG. 10D, it is preferable to estimate the illuminance using a probability distribution, not a scalar value.

The vehicle image processing apparatus includes an onboard camera for capturing an image including an imaging object around a vehicle, an imaging object luminance acquisition unit for acquiring an imaging object luminance at least based on a pixel value for the imaging object in the image captured by the onboard camera, an imaging object lightness acquisition unit for acquiring a lightness of the imaging object around the vehicle, and an ambient illuminance estimation unit for estimating an illuminance around the vehicle from the imaging object luminance acquired by the imaging object luminance acquisition unit and the imaging object lightness acquired by the imaging object lightness acquisition unit using a cause-effect relationship in which the luminance of the imaging object is determined based on the illuminance around the vehicle and the lightness of the imaging object.

As mentioned above, the exposure control may be performed when the onboard camera captures the image (see FIG. 2) whose imaging range contains the road surface painted with the lane marking (white line) ahead of the vehicle. In this case, the cause-effect relationship model in FIG. 3 is available between the external environment around the vehicle and the captured image. This cause-effect relationship model represents the cause-effect relationship in which the luminance of the imaging object such as the road surface or the lane marking (white line) is determined based on the illuminance around the vehicle and the lightness of the imaging object. The cause-effect relationship can be used to estimate the illuminance around the vehicle from the luminance and the lightness of the imaging object. In this manner, the other onboard applications can be provided with information about the illuminance around the vehicle.

### BRIEF DESCRIPTION OF THE DRAWINGS

Other objects, features and advantages of the present invention will become more apparent from the following detailed description made with reference to the accompanying drawings, in which:

FIG. 1 is a block diagram showing the construction of a vehicle image processing apparatus 10;

FIG. 2 is an image ahead of a vehicle imaged by an onboard camera;

FIG. 3 is a cause-effect relationship model;

FIG. 4A is a cause-effect relationship model among camera control variable v8, road surface pixel variable V11, and road surface luminance variable v6;

FIG. 4B is a cause-effect relationship model among camera control variable v8, white line pixel variable v12, and white line luminance variable v7;

FIG. 4C is a cause-effect relationship model among camera control variable v8, sky area pixel variable v10, and sky luminance variable v1;

FIG. 4D is a cause-effect relationship map among a camera control value, a luminance, and a pixel value;

FIG. 5 is a flowchart showing a luminance estimation process according to a first embodiment;

FIG. 6A is a cause-effect relationship model among road surface luminance variable v6 and camera control variable v8;

FIG. 6B is a cause-effect relationship map between road surface luminance variable v6 and camera control variable v8;

FIG. 7A is a cause-effect relationship model among road surface lightness variable v2, illuminance variable v4, headlamp state variable v5, and road surface luminance variable v6;

FIG. 7B is a cause-effect relationship model among white line lightness variable v3, lightness variable v4, headlamp state variable v5, and white line luminance variable v7;

FIG. 7C is a cause-effect relationship map among luminance, illuminance, and lightness (color) when the headlamp is turned off;

FIG. 7D is a cause-effect relationship map among luminance, illuminance, and lightness (color) when the headlamp is turned on;

FIG. 8 is sunlight radiated on a road surface;

FIG. 9 is a flowchart showing a lightness estimation process according to a second embodiment;

FIG. 10A is a cause-effect relationship model between illuminance variable v4 and sensor output variable v9;

FIG. 10B is a cause-effect relationship map between a illuminance and a sensor output value;

FIG. 10C is a cause-effect relationship model between illuminance variable v4 and sky luminance variable v1;

FIG. 10D is a cause-effect relationship map for estimating a illuminance using probability distribution;

FIG. 11 is a flowchart showing a illuminance estimation process according to a third embodiment;

FIG. 12A is a cause-effect relationship model among road surface lightness variable v2, illuminance variable v4, headlamp state variable v5, and road surface luminance variable v6;

FIG. 12B is a cause-effect relationship model between white line lightness variable v3, illuminance variable v4, headlamp state variable v5, and white line luminance variable v7;

FIG. 12C is a cause-effect relationship map among luminance, illuminance, and lightness (color) when the headlamp is turned off; and

FIG. 12D is a cause-effect relationship map among luminance, illuminance, and lightness (color) when the headlamp is turned on.

### DETAILED DESCRIPTION

Embodiments of the present invention will be described in further detail with reference to the accompanying drawings. Though the following embodiments illustrate the present invention as applied to left-side traffic, the present invention may also be applicable to right-side traffic if the right-left relationship is reversed.

### First Embodiment

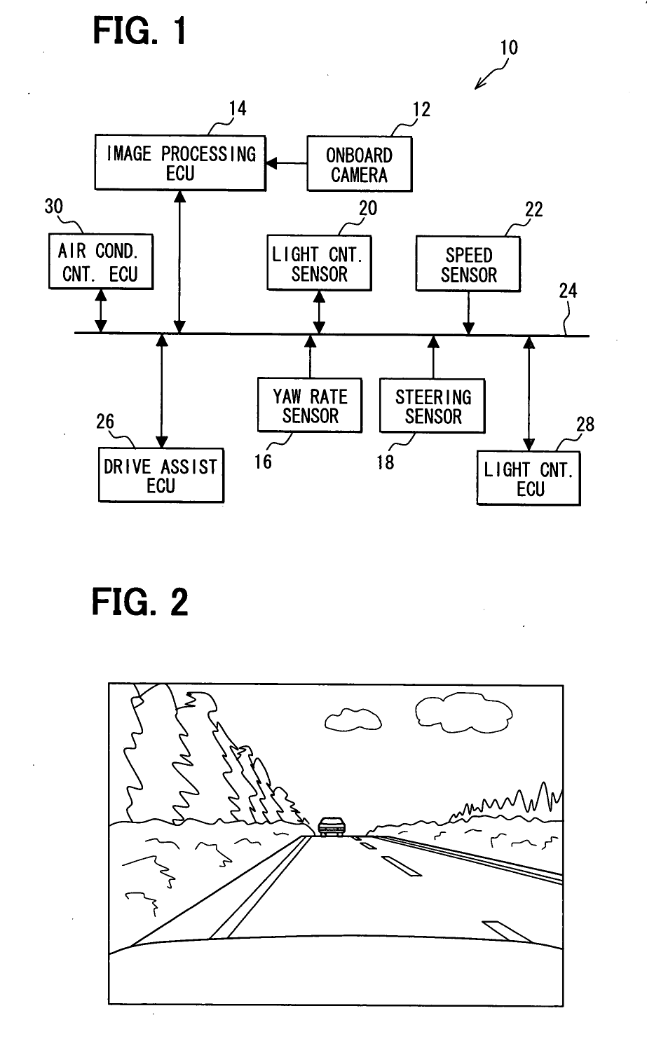

FIG. 1 is a block diagram showing the construction of a vehicle image processing apparatus 10 according to the invention. The vehicle image processing apparatus 10 includes an onboard camera 12, an image processing ECU 14, a yaw rate sensor 16, a steering sensor 18, a light control system sensor 20, and a vehicle speed sensor 22. These components are connected with each other via a vehicle LAN 24. The vehicle LAN 24 also connects with a drive assist ECU 26, a light control ECU 28, and an air controller ECU 30.

The onboard camera 12 is equivalent to a CCD camera using an imaging element such as a CCD and is mounted near an inside rear view mirror, for example. The onboard camera 12 periodically and successively captures a range of image, i.e., an imaging range, as shown in FIG. 2. The imaging range contains, for example, a road surface painted with a lane marking (white line) and the sky ahead of the vehicle.

The onboard camera 12 can adjust camera control parameters in accordance with an instruction from the image processing ECU 14. The camera control parameters include an aperture, a shutter speed, and a gain of an output signal (image signal) supplied to the image processing ECU 14. The onboard camera 12 outputs an image signal along with horizontal and vertical synchronization signals of an image to the image processing ECU 14. The image signal represents pixel value information that indicates the degree of brightness of a captured image on a pixel basis.

The image processing ECU 14 is equivalent to a computer containing a CPU, ROM, RAM, and VRAM (not shown). The VRAM temporarily stores data for a given time duration of image signal that is continuously captured by the onboard camera 12. The CPU performs a specified image process on the image signal data stored in the VRAM in accordance with a program stored in the ROM.

The image processing ECU 14 performs an exposure control process based on the image signal data output from the onboard camera 12. The exposure control process adjusts camera control values for the camera control parameters so that an object to be imaged such as a road surface or a white line can provide a pixel value available for the subsequent image process.

The image processing ECU 14 performs an image recognition process using pixel-based pixel value information about an image. The image recognition process configures an edge threshold value for recognizing a lane marking (white line) on the road surface to be imaged. The process recognizes the imaged white line based on the configured edge threshold value. The process outputs lane position information based on the recognized white line to the drive assist ECU 26 via the vehicle LAN 24

The image processing ECU 14 further performs the exposure control process and a luminance estimation process to be described. When the luminance estimation process generates estimated luminance information, the image processing ECU 14 outputs it to various onboard applications via the vehicle LAN 24. The estimated luminance information concerns the road surface, the white line painted on the road surface, and the sky ahead of the vehicle.

The yaw rate sensor 16 successively detects a yaw rate of the vehicle. The steering sensor 18 successively detects a steering angle. The light control system sensor 20 is used for the light control ECU 28 and automatically turns on a headlamp of the vehicle in accordance with the illuminance around the vehicle. The light control system sensor 20 outputs a detection signal corresponding to the illuminance around the vehicle to the light control ECU 28 via the vehicle LAN 24. The vehicle speed sensor 22 detects a vehicle's speed.

The drive assist ECU 26 performs various control processes. One example is a lane departure warning by generating a warning for the vehicle not to cross the white line. Another example is to assist in keeping track of a lane by generating a specified steering torque so as not to cross the white line.

The light control ECU 28 automatically turns on or off a position lamp and a headlamp based on a detection signal from the light control system sensor 20. In addition, the light control ECU 28 provides an adaptive front lighting system that controls light distribution of the headlamp in accordance with a vehicle speed, a yaw rate, and a steering angle.

The following describes the luminance estimation process by the image processing ECU 14. The luminance estimation process uses an image signal output from the onboard camera 12 to estimate (true) luminance (glare) of the road surface, the white line painted on the road surface, and the sky ahead of the vehicle as an image captured by the onboard camera 12. The luminance estimation process will be described below.

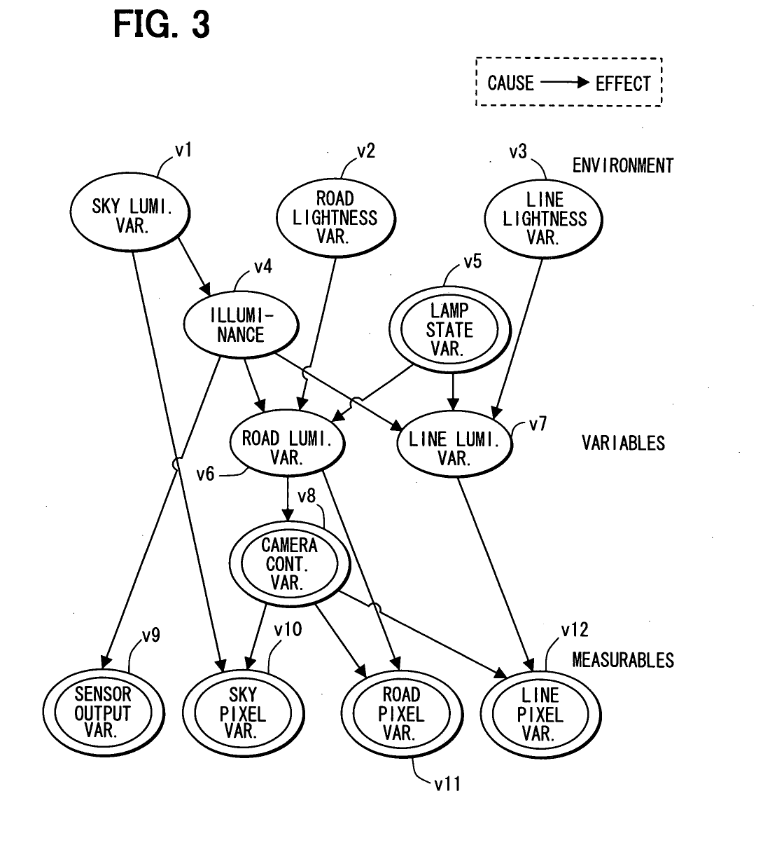

Let us suppose that the exposure control is performed when the onboard camera 14 captures an image (see FIG. 2) whose imaging range contains the road surface painted with the white line and the sky ahead of the vehicle. There is a cause-effect relationship as shown in FIG. 3 between an external environment around the vehicle and the captured image. FIG. 3 diagrams a cause-effect relationship model showing the cause-effect relationship between a variable to be estimated and a measurable variable. In FIG. 3, arrows among variables v1 through v12 indicate that the cause-effect relationship is available. An origin of the arrow corresponds to the cause and an ending point thereof corresponds to the effect of the cause-effect relationship. The variables v5 and v8 through v12 are measurable and are enclosed in a double circle to be distinguished from the other variables.

It will be understood that the cause-effect relationship model can be used for various estimations. For example, there is available “estimation of an effect from a measured cause (forward direction of the arrow)” or “estimation of a cause from a measured effect (backward direction of the arrow).” These estimations can be propagated along the arrows among the variables, making it possible to estimate the variable v2 or v3 not directly connected with measurable variables through the arrows.

The onboard camera 12 performs the exposure control in accordance with the external environment during imaging such as lightness, luminance, and color of objects to be imaged including the road surface, the white line, and the sky ahead of the vehicle. The exposure control successively adjusts the camera control parameters including the aperture, the shutter speed, and the output signal gain. The exposure control process adjusts camera control values for the camera control parameters so that an object to be imaged can provide a pixel value available for the subsequent image process. The pixel value indicates the degree of brightness of a captured image on a pixel basis.

When focusing attention on the exposure control, determining an external environment during imaging determines a camera control value to be adjusted to the target pixel value. It can be understood that there is a cause-effect relationship between the external environment during imaging (cause) and the camera control value (effect). The external environment during imaging can be estimated from the camera control value by retroactively keeping track of the cause-effect relationship from the effect to the cause.

According to the above-mentioned cause-effect relationship, an image captured by the onboard camera 12 contains an imaging object, and its pixel value is determined based on the imaging object's luminance and the camera control value. The cause-effect relationship can be used to estimate a vehicle's external environment such as the luminance of the imaging object from a camera control value and a pixel value for the imaging object. In this manner, the other onboard applications can be provided with information about the luminance of the imaging object.

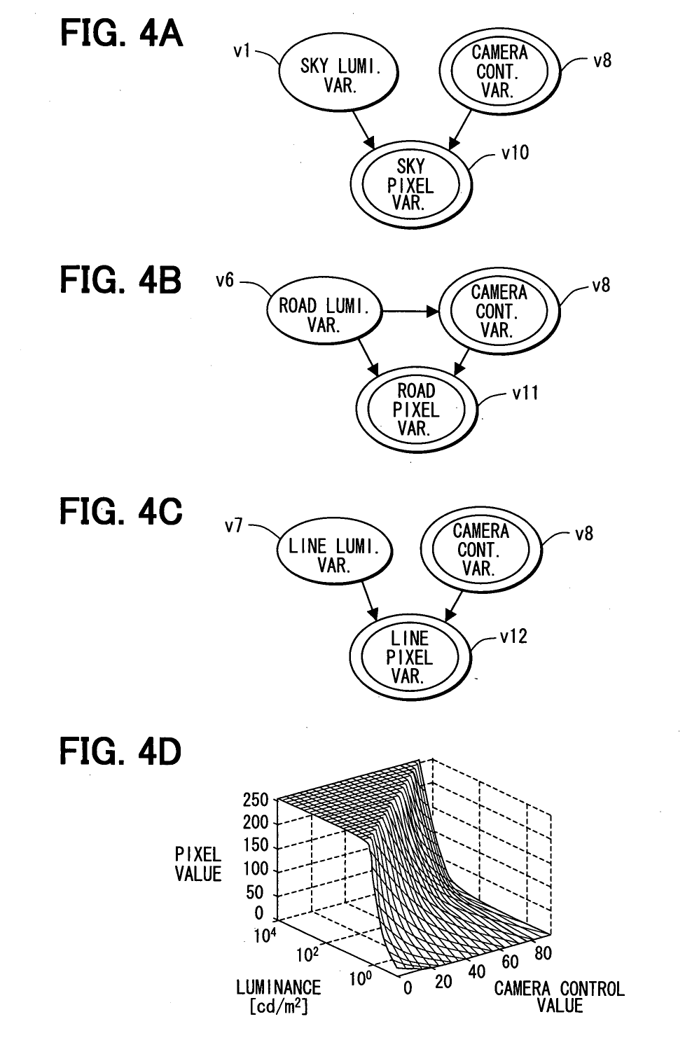

FIG. 4A is a model of cause-effect relationship among the variables v8, v10, and v1 extracted from the cause-effect relationship model in FIG. 3. The variable v8 represents a measurable camera control variable. The variable v10 is measurable and represents a pixel value variable (sky area pixel value) for a sky area in the image. The variable v1 (sky luminance variable) is an estimation target and represents true luminance of the sky ahead of the vehicle. As shown in FIG. 4A, the sky area pixel variable v10 is directly connected with the camera control variable v8 and the sky luminance variable v10 through arrows. The sky luminance variable v1 can be estimated from the camera control variable v8 and the sky area pixel variable v10.

FIG. 4B is a model of cause-effect relationship among the variables v8, v11, and v6 extracted from the cause-effect relationship model in FIG. 3. The variable v8 represents the camera control variable. The variable v11 is measurable and represents a pixel value variable (road surface pixel value) for a road surface in the image. The variable v6 (road surface luminance variable) is an estimation target and represents true luminance of the road surface. As shown in FIG. 4B, the road surface pixel variable v11 is directly connected with the camera control variable v8 and the road surface luminance variable v6 through arrows. The surface luminance variable v6 can be estimated from the camera control variable v8 and the road surface pixel variable v11.

FIG. 4C is a model of cause-effect relationship among the variables v8, v12, and v7 extracted from the cause-effect relationship model in FIG. 3. The variable v8 represents the camera control variable. The variable v12 is measurable and represents a pixel value variable (white line pixel value) for a white line in the image. The variable v7 (white line luminance variable) is an estimation target and represents true luminance of the white line. As shown in FIG. 4C, the white line pixel variable v12 is directly connected with the camera control variable v8 and the white line luminance variable v7 through arrows. The white line luminance variable v7 can be estimated from the camera control variable v8 and the white line pixel variable v12.

Each of the cause-effect relationship models in FIGS. 4A through 4C is provided with a cause-effect relationship map using the camera control value, the luminance, and the pixel value as shown in FIG. 4D. The cause-effect relationship map is stored in the RAM correspondingly to each cause-effect relationship model. The target variable can be estimated by assigning a measurable variable to each of the corresponding cause-effect relationship maps.

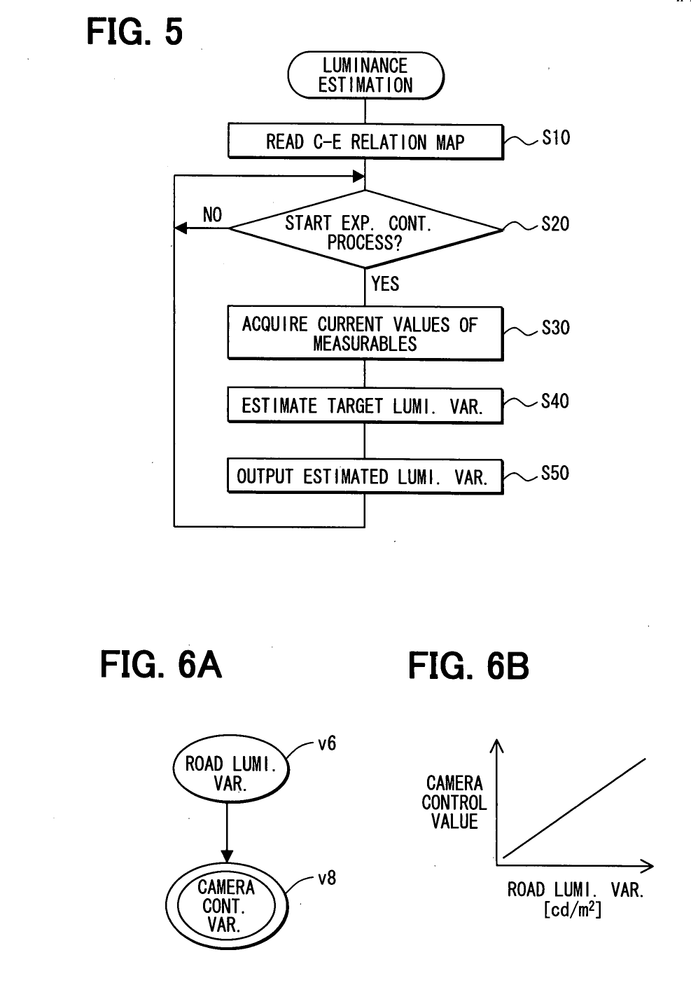

FIG. 5 is a flowchart showing the luminance estimation process. At Step S10 in FIG. 5, the process reads the cause-effect relationship map from the RAM. At Step S20, the process determines whether or not the exposure control process starts or is running. When the determination at Step S20 yields an affirmative result (S20: YES), the process proceeds to Step S30. When the determination at Step S20 yields a negative result (S20: NO), the process waits until the exposure control process starts.

At Step S30, the process acquires a current value for the measurable variable (the camera control variable v8, the sky area pixel variable v10, the road surface pixel variable v11, or the white line pixel variable v12). The white line pixel variable v12 can be acquired as follows. The image recognition process provides lane position information. The white line position can be referenced in the image according to the lane position information. The pixel value can be acquired at the referenced white line position.

At Step S40, the process assigns the variable acquired at Step S30 to the cause-effect relationship map and acquires or estimates the estimation target luminance variable (the sky luminance variable v1, the road surface luminance variable v6, or the white line luminance variable v7). At Step S50, the process outputs the luminance variable estimated at Step S40 to the vehicle LAN 24.

According to the above-mentioned cause-effect relationship, an image captured by the onboard camera 12 contains an imaging object, and its pixel value is determined based on the imaging object's luminance and the camera control value. Using this cause-effect relationship, the vehicle image processing apparatus 10 according to the embodiment estimates a vehicle's external environment such as the luminance of the imaging object from a camera control value and a pixel value for the imaging object. In this manner, the other onboard applications can be provided with information about the luminance of the imaging object.

### Modification 1

The onboard camera 12 according to the embodiment may allow the exposure control to provide a specified value for the pixel value of the road surface. In such case, the cause-effect relationship model in FIG. 4B can be simplified to a cause-effect relationship model between the luminance variable v6 and the camera control variable v8 as shown in FIG. 6A. A cause-effect relationship map as shown in FIG. 6B can be used to represent the road surface luminance variable v6 and the camera control variable v8. The cause-effect relationship map in FIG. 6B may be used to estimate the road surface luminance variable v6 from the camera control variable v8.

### Second Embodiment

The second embodiment has many points in common with the first embodiment. The following mainly describes different points and omits detailed description of the common points. The image processing ECU 14 in the first embodiment performs the luminance estimation process. The luminance estimation process uses an image signal output from the onboard camera 12 to estimate the luminance (glares) of the road surface, the white line, and the sky ahead of the vehicle contained in an image captured by the onboard camera 12.

Differently from the first embodiment, the image processing ECU 14 in the second embodiment performs a lightness estimation process. The lightness estimation process uses an image signal output from the onboard camera 12 to estimate the lightness of the road surface or the white line contained in an image captured by the onboard camera 12. The lightness is equivalent to color or black-white contrast in a monochrome image. The following describes the lightness estimation process.

As mentioned in the first embodiment, the exposure control may be performed when the onboard camera 12 captures the image (see FIG. 2) whose imaging range contains the road surface painted with the lane marking (white line) ahead of the vehicle. In this case, the cause-effect relationship model in FIG. 3 is available between the external environment around the vehicle and the captured image. This cause-effect relationship model represents the cause-effect relationship in which the luminance of the imaging object such as the road surface or the white line is determined based on the illuminance around the vehicle and the lightness of the imaging object. The cause-effect relationship can be used to estimate the lightness of the imaging object from the illuminance around the vehicle and the luminance of the imaging object.

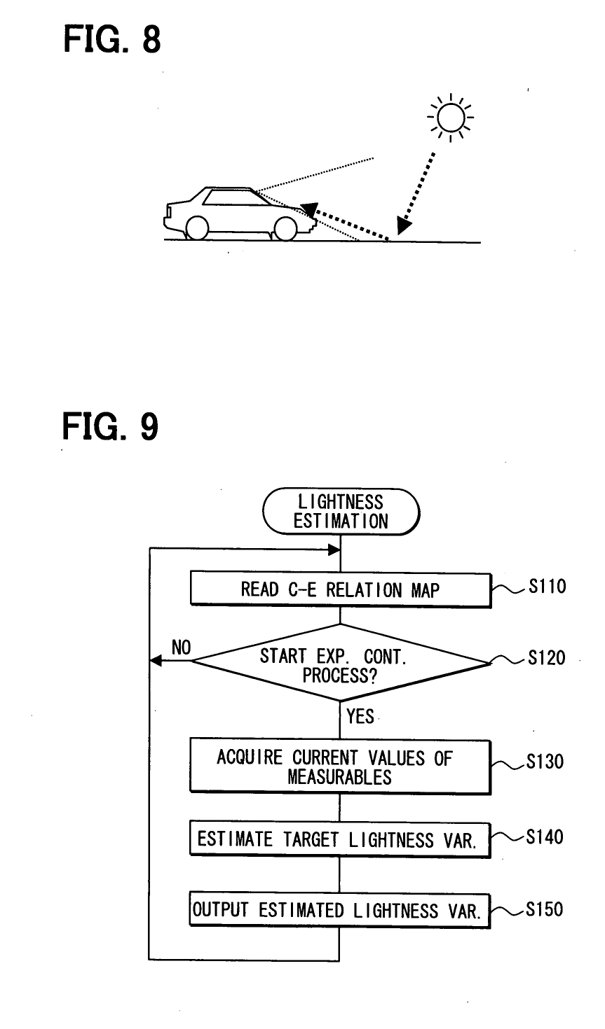

The illuminance around the vehicle affects the lightness of the imaging object because the sunlight radiates on the road surface as shown in FIG. 8. The luminance of the road surface is determined by the illuminance around the vehicle and the lightness of the road surface when it is supposed to be a perfect diffusion surface.

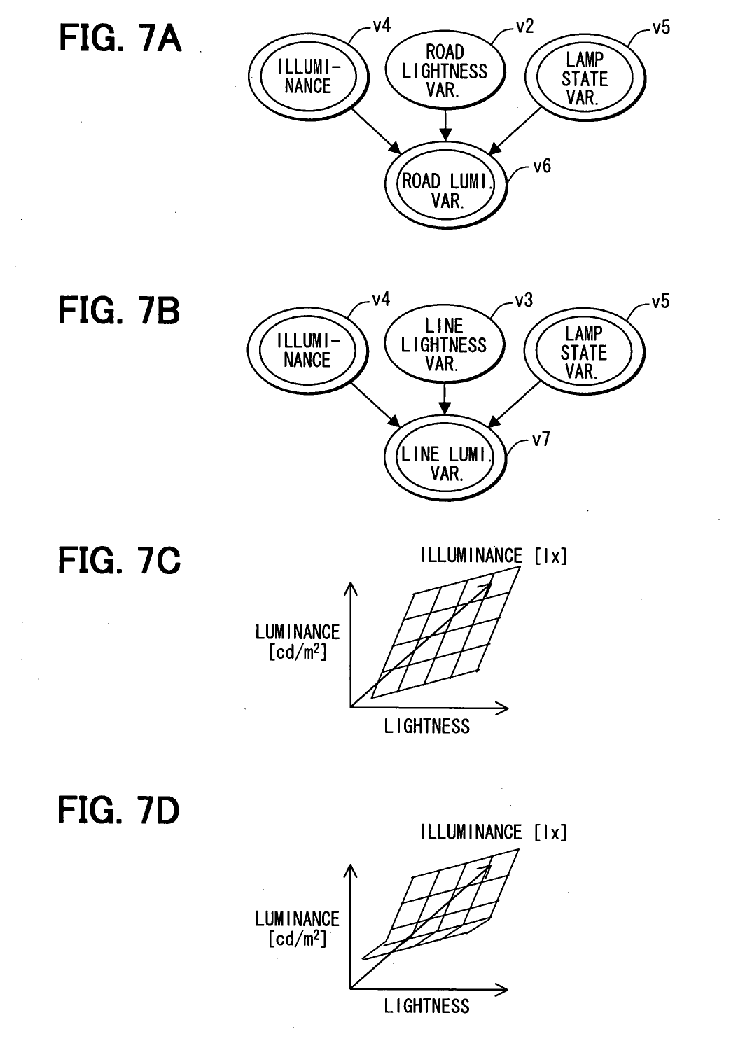

FIG. 7A is a model of cause-effect relationship among the variables v2, v4, v5, and v6 extracted from the cause-effect relationship model in FIG. 3. The variable v2 represents a road surface lightness variable, i.e., a variable for road surface lightness (color). The variable v4 represents a illuminance variable, i.e., a variable for illuminance around the vehicle. The variable v5 represents a headlamp state variable, i.e., a variable for the headlamp state. The variable v6 represents the road surface luminance variable v6. As shown in FIG. 7A, the road surface luminance variable v6 is directly connected with the illuminance variable v4 and the road surface lightness variable v2 through arrows. The road surface lightness variable v2 can be estimated from the road surface luminance variable v6 and the illuminance variable v4.

An onboard lighting system such as a headlamp radiates the light ahead of the vehicle. When the headlamp turns on to radiate the light, it influences the road surface luminance. The influence needs to be considered. Turning on the headlamp permits the cause-effect relationship model containing the headlamp state variable v5 as shown in FIG. 7A. The road surface lightness variable v2 can be estimated from the headlamp state variable v5, the road surface luminance variable v6, and the illuminance variable v4.

FIG. 7B is a model of cause-effect relationship among the variables v3, v4, v5, and v7 extracted from the cause-effect relationship model in FIG. 3. The variable v3 represents a white line lightness variable, i.e., a variable for the white line lightness (color). The variable v4 represents the lightness variable. The variable v5 represents the headlamp state variable. The variable v7 represents the white line luminance variable. As shown in FIG. 7B, the white line luminance variable v7 is directly connected with the illuminance variable v4, the white line lightness variable v3, and the headlamp state variable v5. The white line lightness variable v3 can be estimated from the white line luminance variable v7, the lightness variable v4, and the headlamp state variable v5.

Each of the cause-effect relationship models in FIGS. 7A and 7B is provided with a cause-effect relationship map using the illuminance, the luminance, and the lightness as shown in FIGS. 7C and 7D. The cause-effect relationship map is preferably stored in the RAM correspondingly to each cause-effect relationship model. FIG. 7C shows the cause-effect relationship map when the headlamp turns off. FIG. 7D shows the cause-effect relationship map when the headlamp turns on. Assigning a measurable variable to each cause-effect relationship map can estimate the road surface lightness variable v2 and the white line lightness variable v3 as estimation target variables.

FIG. 9 is a flowchart showing the lightness estimation process. At Step S110 in FIG. 9, the process reads the cause-effect relationship map from the RAM. At Step S120, the process determines whether or not the exposure control process starts or is running. When the determination at Step S120 yields an affirmative result (S120: YES), the process proceeds to Step S130. When the determination at Step S120 yields a negative result (S120: NO), the process waits until the exposure control process starts.

At Step S130, the process acquires a current value for the measurable variable (the headlamp state variable v5, the camera control variable v8, the sky area pixel variable v10, the road surface pixel variable v11, or the white line pixel variable v12). At Step S140, the process estimates the illuminance variable v4, the road surface luminance variable v6, and the white line luminance variable v7 from the variable values acquired at Step S130. The process assigns the estimation result to the cause-effect relationship map and acquires or estimates the estimation target lightness variables (the road surface lightness variable v2 and the white line lightness variable v3). At Step S150, the process outputs the lightness variables estimated at Step S140 to the vehicle LAN 24.

According to the above-mentioned cause-effect relationship, the luminance of the imaging object such as the road surface or the white line is determined based on the illuminance around the vehicle and the lightness of the imaging object. Using this cause-effect relationship, the vehicle image processing apparatus 10 according to the embodiment estimates the lightness of the imaging object from the illuminance around the vehicle and the luminance of the imaging object. In this manner, the other onboard applications can be provided with information about the lightness of the imaging object.

### Third Embodiment

The third embodiment has many points in common with the first and second embodiments. The following mainly describes different points and omits detailed description of the common points. Differently from the first and second embodiments, the image processing ECU 14 in the third embodiment performs an illuminance estimation process that estimates the illuminance around the vehicle using an image signal output from the onboard camera 12. The illuminance estimation process will be described below.

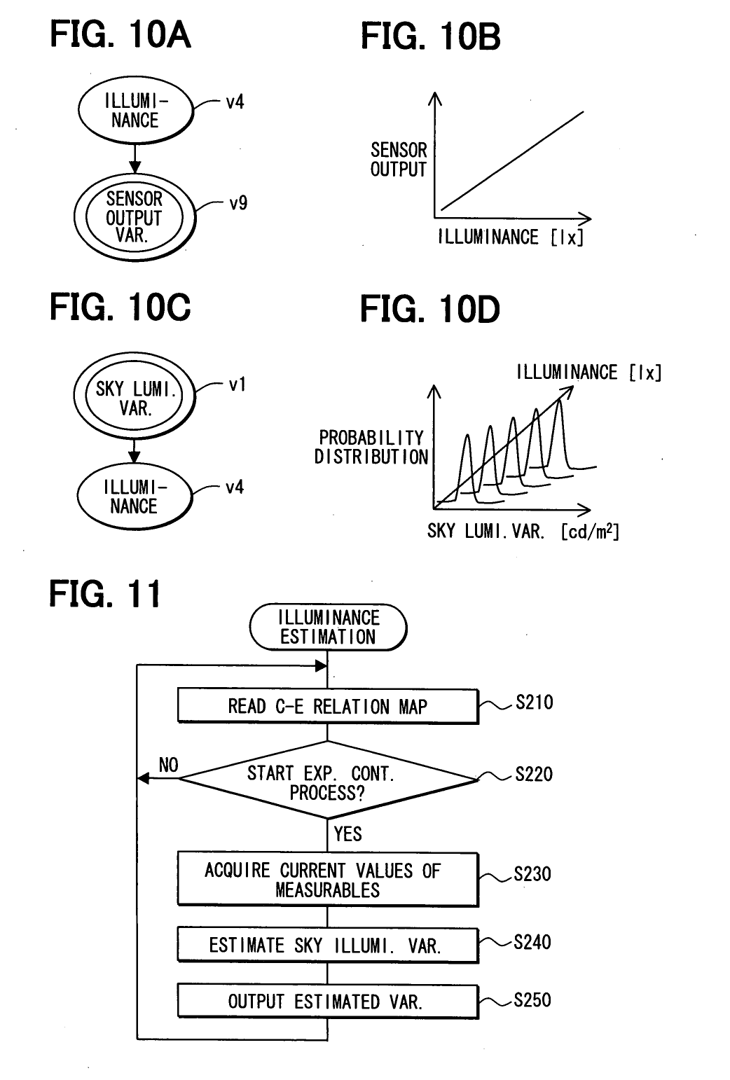

As mentioned in the first embodiment, the exposure control may be performed when the onboard camera 14 captures the image (see FIG. 2) whose imaging range contains the road surface painted with the lane marking (white line) ahead of the vehicle. In this case, the cause-effect relationship model in FIG. 3 is available between the external environment around the vehicle and the captured image. As shown in this cause-effect relationship model, the illuminance variable v4 is determined from a sensor output value variable v9, i.e., the variable for a value output from a light control system sensor or a solar sensor. FIG. 10A shows a model of the cause-effect relationship between the illuminance variable v4 and the sensor output value variable v9 extracted from the cause-effect relationship model in FIG. 3. The cause-effect relationship model in FIG. 10A is represented by a cause-effect relationship map as shown in FIG. 10B.

As is clear from the cause-effect relationship model in FIG. 3, the illuminance variable v4 is directly connected with the sky luminance variable v1. As shown in FIG. 10C, a cause-effect relationship model is available between the illuminance variable v4 and the sky luminance variable v1. There is the cause-effect relationship in which the illuminance around the vehicle is determined based on the luminance of the sky around the vehicle. The cause-effect relationship can be used to estimate the illuminance around the vehicle from the luminance of the sky around the vehicle. In this manner, the other onboard applications can be provided with information about the illuminance around the vehicle without using the light control system sensor or the solar sensor.

It is considered that the illuminance variable v4 is estimated from the sky luminance variable v1 not so accurately. As shown in FIG. 10D, it is preferable to estimate the illuminance using a probability distribution, not a scalar value. As far as the probability distribution is concerned, for example, an experiment is conducted to find an intensity of the cause-effect relationship between variables to be estimated and observed. The cause-effect relationship intensity is preserved as a statistical database. The statistical database is used to estimate the illuminance variable v4 from the sky luminance variable v1 in accordance with a conditional probability equation (e.g., Bayesian decision theory). In this manner, it is possible to acquire the likelihood (probability) of the estimated value based on observations.

FIG. 11 is a flowchart showing the illuminance estimation process. At Step S210 in FIG. 11, the process reads the cause-effect relationship map from the RAM. At Step S220, the process determines whether or not the exposure control process starts or is running. When the determination at Step S220 yields an affirmative result (S220: YES), the process proceeds to Step S230. When the determination at Step S220 yields a negative result (S220: NO), the process waits until the exposure control process starts.

At Step S230, the process acquires a current value for the measurable variable (the headlamp state variable v5, the camera control variable v8, the sky area pixel variable v10, the road surface pixel variable v11, or the white line pixel variable v12). At Step S240, the process estimates the sky luminance variable v1 from the variable value acquired at Step S230. The process assigns the estimation result to the cause-effect relationship map and acquires or estimates the estimation target illuminance variable v4. At Step S250, the process outputs the illuminance variable v4 estimated at Step S240 to the vehicle LAN 24.

There is the cause-effect relationship in which the illuminance around the vehicle is determined based on the luminance of the sky around the vehicle. The vehicle image processing apparatus 10 in the present embodiment can use the cause-effect relationship to estimate the illuminance around the vehicle from the luminance of the sky around the vehicle. In this manner, the other onboard applications can be provided with information about the illuminance around the vehicle without using the light control system sensor or the solar sensor.

### Modification 2

As is clear from the cause-effect relationship model in FIG. 3, there is available the cause-effect relationship in which the luminance of the imaging object such as the road surface or the white line is determined based on the illuminance around the vehicle and the lightness of the imaging object. Accordingly, the use of the cause-effect relationship can estimate the illuminance around the vehicle from the luminance and the lightness of the imaging object.

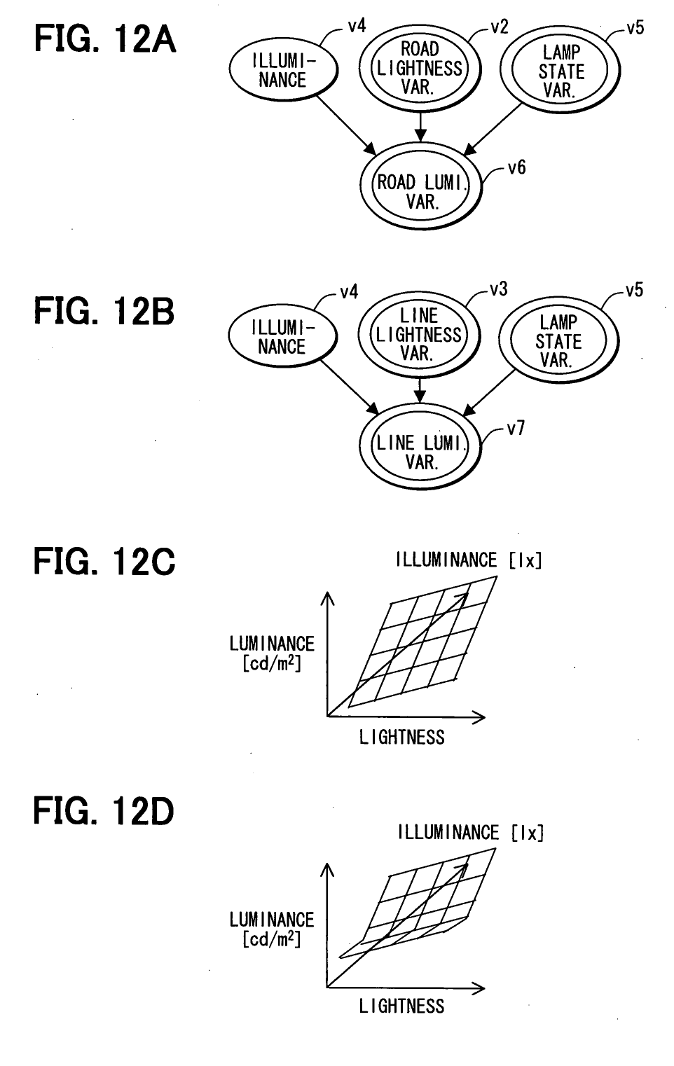

In the cause-effect relationship model of FIG. 3, for example, the illuminance variable v4 is directly connected with the road surface luminance variable v6 through the arrow. The road surface luminance variable v6 is connected to the road surface lightness variable v2. Therefore, the illuminance variable v4 can be estimated from the road surface lightness variable v2 and the road surface luminance variable v6. FIG. 12A shows a model of the cause-effect relationship among the illuminance variable v4, the road surface lightness variable v2, and the road surface luminance variable v6 extracted from the cause-effect relationship model in FIG. 3. When the headlamp turns on to radiate the light, it influences the road surface luminance. The influence needs to be considered. Turning on the headlamp permits the cause-effect relationship model containing the headlamp state variable v5 as shown in FIG. 12A. The cause-effect relationship model can be used to estimate the illuminance variable v4 when the headlamp turns on.

FIG. 12C shows a cause-effect relationship map when the headlamp turns off. FIG. 12D shows a cause-effect relationship map when the headlamp turns on. The cause-effect relationship model in FIG. 12A can be represented by the cause-effect relationship maps in FIGS. 12C and 12D. These cause-effect relationship maps can be used to estimate illuminance variable v4.

In the cause-effect relationship model of FIG. 3, the illuminance variable v4 is directly connected with the white line luminance variable v7 through the arrow. The white line luminance variable v7 is connected to the white line lightness variable v3. Therefore, the illuminance variable v4 can be estimated from the white line lightness variable v3 and the white line luminance variable v7. FIG. 12B shows a model of the cause-effect relationship among the illuminance variable v4, the white line lightness variable v3, and the white line luminance variable v7 extracted from the cause-effect relationship model in FIG. 3. When the headlamp turns on to radiate the light, it influences the road surface luminance. The influence needs to be considered. Turning on the headlamp permits the cause-effect relationship model as shown in FIG. 12B. The cause-effect relationship model can be used to estimate the illuminance variable v4 when the headlamp turns on.

FIG. 12C shows a cause-effect relationship map when the headlamp turns off. FIG. 12D shows a cause-effect relationship map when the headlamp turns on. The cause-effect relationship model in FIG. 12B can be represented by the cause-effect relationship maps in FIGS. 12C and 12D. These cause-effect relationship maps can be used to estimate the illuminance variable v4.

The illuminance estimation process according to the modification is equal to the flowchart in FIG. 11 except Step S240 only. The description about the same steps will be omitted. At Step S240 of the modification, the process estimates the road surface lightness variable v2, the white line lightness variable v3, the road surface luminance variable v6, and the white line luminance variable from the variable values acquired at Step S230. The process assigns the estimation results to the cause-effect relationship map to acquire the illuminance variable v4 as the estimation target.

Although the present invention has been fully described in connection with the preferred embodiment thereof with reference to the accompanying drawings, it is to be noted that various changes and modifications will become apparent to those skilled in the art.

For example, while the first through third embodiments estimate one of the luminance, lightness, and illuminance variables, all the variables may be estimated at the same time. Further, it may be preferable to provide means for specifying a variable to be estimated and specify the variable to be estimated according to a user operation.

Such changes and modifications are to be understood as being within the scope of the present invention as defined by the appended claims.

What is claimed is:

1. A vehicle image processing apparatus comprising:
an onboard camera for capturing an image including an imaging object around a vehicle;
a camera control value setup unit configured for setting a camera control value of at least one of camera control parameters such as an onboard camera aperture, a shutter speed, and an output signal gain in accordance with an external environment for the vehicle during imaging;
an imaging object pixel value acquisition unit configured for acquiring a pixel value for the imaging object in the image captured by the onboard camera; and
an imaging object luminance estimation unit configured for estimating a luminance of the imaging object from the camera control value set by the camera control value setup unit and the pixel value for the imaging object acquired by the imaging object pixel value acquisition unit using a cause-effect relationship in which the pixel value for the imaging object in the image captured by the onboard camera is determined based on the luminance of the imaging object and the camera control value.

2. The vehicle image processing apparatus according to claim 1,
wherein the onboard camera captures a road around the vehicle as the imaging object, and
the imaging object luminance estimation unit estimates the luminance of the road surface.

3. The vehicle image processing apparatus according to claim 2 further comprising:
a lane divider recognition unit configured for recognizing a lane marking that exists in the image captured by the onboard camera with a road surface included therein,
wherein the imaging object luminance estimation unit estimates the luminance of the lane marking.

4. The vehicle image processing apparatus according to claim 1,
wherein the onboard camera captures a sky around the vehicle as the image including the imaging object, and
the imaging object luminance estimation unit estimates the luminance of the sky.

5. A vehicle image processing apparatus comprising:
an onboard camera configured for capturing an image including a road surface around a vehicle;
a camera control value setup unit configured for setting a camera control value of at least one of camera control parameters such as an onboard camera aperture, a shutter speed, and an output signal gain so as to provided a specified pixel value for the road surface in the image captured by the onboard camera; and
a road surface luminance estimation unit configured for estimating a luminance of the road surface from the camera control value using a cause-effect relationship in which the luminance of the road surface is determined based on the camera control value when the camera control value setup unit sets the camera control value so as to provide the specified pixel value for the road surface.

6. A vehicle image processing apparatus comprising:
an ambient illuminance acquisition unit configured for acquiring an illuminance around a vehicle;
an onboard camera configured for capturing an image including an imaging object around the vehicle;
an imaging object luminance acquisition unit configured for acquiring an imaging object luminance estimated at least based on a pixel value for the imaging object in the image captured by the onboard camera; and
an imaging object lightness estimation unit configured for estimating an imaging object lightness from the illuminance acquired by the ambient illuminance acquisition unit and the imaging object luminance using a cause-effect relationship in which the imaging object luminance is determined based on the illuminance around the vehicle and the imaging object lightness.

7. The vehicle image processing apparatus according to claim 6,
wherein the onboard camera captures a road around the vehicle as the image including the imaging object, and
the imaging object lightness estimation unit estimates the lightness of the road surface.

8. The vehicle image processing apparatus according to claim 7 further comprising:
a lane marking recognition unit configured for recognizing a lane marking that exists in the image captured by the onboard camera with a road surface included therein,
wherein the imaging object lightness estimation unit estimates the lightness of the lane marking.

9. The vehicle image processing apparatus according to claim 7 further comprising:
a lighting unit disposed on the vehicle and configured for emitting a light that lights around the vehicle,
wherein the imaging object lightness estimation unit estimates the lightness of the imaging object from the illuminance of the light emitted from the lighting unit, the illuminance acquired by the ambient illuminance acquisition unit, and the luminance of the imaging object based on a cause-effect relationship that the luminance of the imaging object is determined by the illuminance of the light emitted from the lighting unit, the illuminance around the vehicle, and the lightness of the imaging object when the lighting unit is being turned on.

10. A vehicle image processing apparatus comprising:
an onboard camera configured for capturing an image including a sky around a vehicle;
a sky luminance acquisition unit configured for acquiring a luminance of the sky around the vehicle at least based on a pixel value for the sky in the image captured by the onboard camera; and
an ambient illuminance estimation unit configured for acquiring an illuminance around the vehicle from the luminance of the sky acquired by the sky luminance acquisition unit using a cause-effect relationship in which the illuminance around the vehicle is determined based on the luminance of the sky around the vehicle.

11. A vehicle image processing apparatus comprising:
an onboard camera configured for capturing an image including an imaging object around a vehicle;
an imaging object luminance acquisition unit configured for acquiring an imaging object luminance at least based on a pixel value for the imaging object in the image captured by the onboard camera;
an imaging object lightness acquisition unit configured for acquiring a lightness of the imaging object around the vehicle; and
an ambient illuminance estimation unit configured for estimating an illuminance around the vehicle from the imaging object luminance acquired by the imaging object luminance acquisition unit and the imaging object lightness acquired by the imaging object lightness acquisition unit using a cause-effect relationship in which the luminance of an imaging object is determined based on the illuminance around the vehicle and the lightness of the imaging object.

12. The vehicle image processing apparatus according to claim 11,
wherein the onboard camera captures a road around the vehicle as the image including the imaging object,
the imaging object luminance acquisition unit acquires a road surface luminance based on the pixel value of a road surface of the image,
the imaging object lightness acquisition unit acquires a road surface lightness, and
the ambient illuminance estimation unit estimates the illuminance around the vehicle from the road surface luminance acquired by the imaging object luminance acquisition unit and the road surface lightness acquired by the imaging object lightness acquisition unit based on a cause-effect relationship that the road surface luminance is determined by the illuminance around the vehicle and the road surface lightness.

13. The vehicle image processing apparatus according to claim 12 further comprising:
a lane marking recognition unit configured for recognizing a lane marking that exists in the image captured by the onboard camera with a road surface included therein,
wherein the imaging object luminance acquisition unit acquires a lane marking luminance based on the pixel value of the lane marking in the image,
the imaging object lightness acquisition unit acquires a lane marking lightness, and
the ambient illuminance estimation unit estimates the illuminance around the vehicle from the lane marking luminance acquired by the imaging object luminance acquisition unit and the lane marking lightness acquired by the imaging object lightness acquisition unit based on a cause-effect relationship that the lane marking luminance is determined by the illuminance around the vehicle and the lane marking lightness.
